(19) United States
(12) Patent Application Publication
(10) Pub. No.: US 2010/0039929 A1
(43) Pub. Date: Feb. 18, 2010

(54) INDOOR WIRELESS POSITIONING SYSTEM AND METHOD

(75) Inventors: Seong-Yun Cho, Daejeon-city (KR); Byung-Doo Kim, Daejeon-city (KR); Young-Su Cho, Seoul (KR); Wan-Sik Choi, Daejeon-city (KR); Jong-Hyun Park, Daejeon-city (KR)

Correspondence Address: Muncy, Geissler, Olds & Lowe, PLLC, P.O. BOX 1364, FAIRFAX, VA, 22038-1364, US

(73) Assignee: Electronics and Telecommunications Research Instit, Daejeon-city (KR)

(21) Appl. No.: 12/517,575

(22) PCT Filed: Oct. 29, 2007
(86) PCT No.: PCT/KR2007/005357

§ 371 Date: Jun. 4, 2009

(30) Foreign Application Priority Data
Dec. 8, 2006 (KR) 10-2006-0125107

(51) Int. Cl. H04L 12/28; H04L 12/26; G06F 11/07

(52) U.S. Cl. 370/216; 370/252; 370/254

(57) ABSTRACT

Provided is an indoor wireless positioning system and method including: a signal receiving unit receiving first signals from wireless communication access points and measuring strengths of the received first signals and a position estimating unit estimating a current position by comparing the strengths of the first signals measured by the signal receiving unit with a table recording strengths of second signals predicted by a simulation for indoor space the system is currently positioned. Accordingly, it is possible to rapidly and accurately create a fingerprint database and calculate position information on the terminal in the terminal or the server on the basis of the database information.

### TECHNICAL FIELD

The present invention relates to an indoor wireless positioning system and method, and more particularly, to a terminal-based positioning method and a server-based positioning method of providing a position of a terminal capable of creating a fingerprint database for indoor positioning using a wireless communication system such as a wireless local area network (WLAN), bluetooth, or an ultra-wideband (UWB) and using a software-based simulator.

### BACKGROUND ART

In general, due to the development of satellite-based global positioning system (GPS) receivers, GPS receivers have been used as positioning sensors in commercial vehicle navigation systems. For example, using position information on a vehicle acquired by the GPS receiver, a location based service (LBS) providing, for example, traffic information or a location-based information service is provided.

However, in some cases, such as while indoors, in a tunnel, in an underground parking lot, or in the center of the city, the GPS receiver cannot completely or can only partially receive a GPS satellite signal. Therefore, there is a problem in that the GPS cannot continuously provide position information.

Accordingly, various methods for indoor positioning have been studied. For example, the methods may include a method of using a high-sensitivity GPS receiver, pedestrian dead-reckoning using a Micro-Electro-Mechanical System (MEMS) sensor, and a wireless positioning method using a wireless communication signal. In particular, the wireless positioning system and method for positioning in the same manner as that of the GPS have been actively studied and developed with growing concerns.

Indoor wireless positioning can be implemented using wireless communication devices using a wireless local area network (WLAN), bluetooth, or an ultra-wideband (UWB). Using the aforementioned devices has an advantage in that an infrastructure for the wireless communication is constructed indoors in advance.

When the GPS is used outdoors, the GPS satellite and the receiver are in time synchronization with each other, so that a position is calculated using a time of arrival (ToA). However, a wireless communication access point (AP) for the indoor positioning and a modem are not in time synchronization with each other, so that the ToA cannot be used.

In addition, in the WLAN, the APs are not in synchronization with each other, so that a time difference of arrival (TDOA) cannot be used either. Accordingly, in this case, a position of the modem is calculated by measuring a strength of a signal transmitted from an AP.

There are two methods of calculating the position of the modem by measuring the strength of the signal. One method is to estimate a distance between the AP and the modem using a propagation attenuation model of the signal to calculate the position by triangulation. The other method is to use a fingerprint database to estimate the position. Recently, the method of calculating the position in the fingerprint method has been widely studied. However, there are problems in that it takes much time to construct the database and it is difficult to accurately construct data.

### DISCLOSURE OF INVENTION

### Technical Problem

The present invention provides an indoor wireless positioning system comprising: a signal receiving unit receiving first signals from wireless communication access points and measuring strengths of the received first signals; and a position estimating unit estimating a current position by comparing the strengths of the first signals measured by the signal receiving unit with a table recording strengths of second signals predicted by a simulation for indoor space the system is currently positioned.

According to an aspect of the present invention, there is provided an indoor wireless positioning system including: a signal receiving unit receiving first signals from wireless communication access points and measuring strengths of the received first signals and a position estimating unit estimating a current position by comparing the strengths of the first signals measured by the signal receiving unit with a table recording strengths of second signals predicted by a simulation for indoor space the system is currently positioned.

In the above aspect of the present invention, the signal receiving unit may receive the first signals transmitted from a number of the wireless communication access points and measure the strength of the first signal received from each access point.

In addition, the position estimating unit may include a simulation unit which predicts the strengths of the second signals through the simulation using a signal propagation attenuation model on the basis of indoor map information showing a cross-section of the indoor space, indoor wall information including the thickness and material of an indoor wall, strengths of signals transmitted from the access points, position information on the access points, and movement information on the system.

In addition, the position estimating unit may include a database unit which predicts the strengths of the second signals in the indoor space the system is currently positioned through the simulation for a number of the access points and records and stores the strength of the second signal with respect to each access point in the table.

In addition, the position estimating unit may include a position determining unit which receives the first signals transmitted from a number of the wireless communication access points, compares the measured strength of the first signal from each access point with the table recording the strengths of the second signals predicted by the simulation of the indoor space the system is currently positioned for a number of the access points, and determines a position stored in the table corresponding to a strength of a second signal with a minimum error as a current position.

In addition, the system may further include a signal correcting unit which receives the strength of the second signal predicted by the position estimating unit at the current position of the system and a third signal transmitted from the access point at a known position in the indoor space and corrects the strength of the second signal predicted by the position estimating unit according to an error calculated using a strength of the third signal and the strength of the second signal.

### Technical Solution

According to another aspect of the present invention, there is provided an indoor wireless positioning method including: (a) receiving first signals transmitted from wireless communication access points and measuring strengths of the received first signals; and (b) estimating a current position by comparing the strengths of the first signals measured in (a) with a table recording strengths of second signals predicted by a simulation for indoor space the system is currently positioned.

According to another aspect of the present invention, there is provided an indoor wireless positioning method using an indoor wireless positioning system constructed with a mobile communication terminal and a positioning server, the method including: (a) the mobile communication terminal entering an indoor space and requesting information on a current position of the positioning server; (b) the positioning server receiving the request requesting the mobile communication terminal to select a mode from among a terminal-based position calculation mode and a server-based position calculation mode; (c) when the mobile communication terminal selects the terminal-based position calculation mode, the positioning server providing a table recording strengths of second signals predicted by a simulation of the indoor space where the mobile communication terminal is currently positioned to the mobile communication terminal; and (d) the mobile communication terminal receiving first signals transmitted from wireless communication access points, comparing measured strengths of the first signals with the strengths of the second signals recorded in the table, and determining a position stored in the table corresponding to a strength of a second signal with a minimum error as a current position.

### ADVANTAGEOUS EFFECTS

As described above, there is provided to the user an effective entire system and method for indoor wireless positioning capable of overcoming a limitation imposed by an indoor environment having built-in access points using indoor wireless communication devices using WLAN, Bluetooth, and UWB, providing the indoor environment-based fingerprint database creation method in order to provide reliable positioning information to a user, providing a database-based terminal position estimating method, and providing a terminal/server-based position estimating method.

In addition, a simulation error of the software tool can be corrected using the hardware tool, so that it is possible to accurately provide an indoor wireless positioning result.

The present invention is not limited to the aforementioned embodiments, but may be modified for use in applications such as indoor positioning based on the wireless communication using the WLAN and UWB or outdoor wireless positioning by those skilled in the art.

### DESCRIPTION OF DRAWINGS

The above and other features and advantages of the present invention will become more apparent by describing in detail exemplary embodiments thereof with reference to the attached drawings in which:

FIG. 1 is a view showing a structure of a terminal-based indoor wireless positioning system according to an embodiment of the present invention;

FIG. 2 is a flowchart showing a terminal-based indoor wireless positioning method according to an embodiment of the present invention;

FIG. 3 is a view showing a structure of a server-based indoor wireless positioning system according to an embodiment of the present invention;

FIG. 4 is a flowchart showing a server-based indoor wireless positioning method according to an embodiment of the present invention;

FIGS. 5A to 5C are views showing a detailed structure of an indoor wireless positioning system according to an embodiment of the present invention;

FIG. 6 is a flowchart showing a simulation process for a strength of a second signal according to an embodiment of the present invention;

FIG. 7 is a view showing a table for strengths of second signals according to an embodiment of the present invention;

FIG. 8 is a view showing signal correction operations after a simulation of strengths of second signals according to an embodiment of the present invention;

FIG. 9 is a view showing a method of estimating a position of a terminal by comparing strengths of first signals with a table for strengths of second signals; and

FIG. 10 is a flowchart showing an indoor wireless positioning method applying terminal-based and server-based calculation modes according to an embodiment of the present invention.

### BEST MODE

According to another aspect of the present invention, there is provided an indoor wireless positioning method including: (a) receiving first signals transmitted from wireless communication access points and measuring strengths of the received first signals; and (b) estimating a current position by comparing the strengths of the first signals measured in (a) with a table recording strengths of second signals predicted by a simulation for indoor space the system is currently positioned.

In the above aspect of the present invention, in (a), the first signals transmitted from a number of the wireless communication access points may be received, and the strength of the first signal received from each access point may be measured.

In addition, (b) may include predicting the strengths of the second signals through the simulation using a signal propagation attenuation model on the basis of indoor map information showing a cross-section of the indoor space, indoor wall information including the thickness and material of an indoor wall, strengths of signals transmitted from the access points, position information on the access points, and movement information on the system.

In addition, (b) may include predicting the strengths of the second signals in the indoor space the system is currently positioned through the simulation for a number of the access points and recording and storing the strength of the second signal for each access point in the table.

In addition, (b) may include receiving the first signals transmitted from a number of the wireless communication access points, comparing the measured strength of the first signal from each access point with the table recording the strengths of the second signals predicted by the simulation of the indoor space the system is currently positioned with respect to a number of the access points, and determining a position stored in the table corresponding to a strength of a second signal with a minimum error as a current position.

In addition, the method may further include receiving the strength of the second signal predicted in (b) at the current position and a third signal transmitted from the access point at a known position in the indoor space and correcting the strength of the second signal predicted in (b) according to an error calculated using a strength of the third signal.

According to another aspect of the present invention, there is provided an indoor wireless positioning method using an indoor wireless positioning system constructed with a mobile communication terminal and a positioning server, the method including: (a) the mobile communication terminal entering an indoor space and requesting information on a current position of the positioning server; (b) the positioning server receiving the request requesting the mobile communication terminal to select a mode from among a terminal-based position calculation mode and a server-based position calculation mode; (c) when the mobile communication terminal selects the terminal-based position calculation mode, the positioning server providing a table recording strengths of second signals predicted by a simulation of the indoor space where the mobile communication terminal is currently positioned to the mobile communication terminal; and (d) the mobile communication terminal receiving first signals transmitted from wireless communication access points, comparing measured strengths of the first signals with the strengths of the second signals recorded in the table, and determining a position stored in the table corresponding to a strength of a second signal with a minimum error as a current position.

In the above aspect of the present invention, the method may further include: (e) when the mobile communication terminal selects the server-based position calculation mode in (c), the terminal receiving the first signals transmitted from the wireless communication access points and providing the measured strengths of the first signals to the positioning server; and (f) the positioning server comparing the provided strengths of the first signals with the table recording the strengths of the second signal predicted by the simulation of the indoor space where the mobile communication terminal is currently positioned and determining a position stored in the table corresponding to a strength of a second signal with a minimum error as a current position.

In addition, in (d), the strength of the second signal and a third signal transmitted from the access point at a known position in the indoor space may be received, and the strength of the second signal may be corrected according to an error calculated using a strength of the third signal and the strength of the second signal.

### Mode for Invention

Hereinafter, exemplary embodiments of the present invention will be described in detail with reference to the attached drawings.

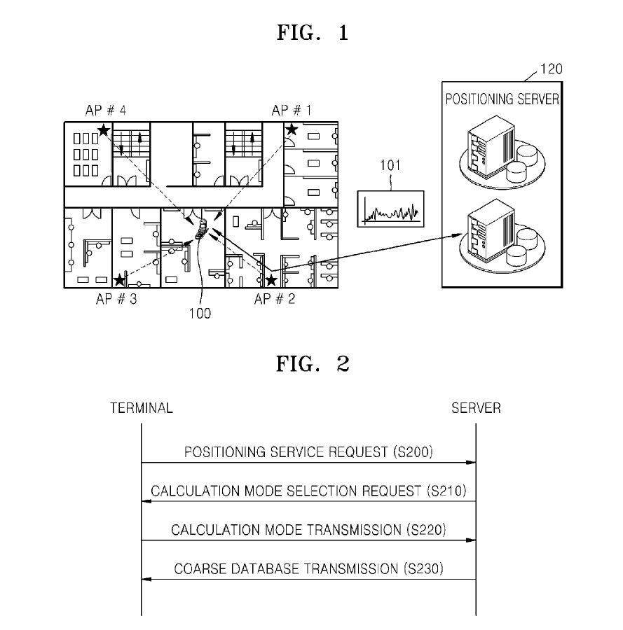

FIG. 1 is a view showing a structure of a terminal-based indoor wireless positioning system according to an embodiment of the present invention. Referring to FIG. 1, the indoor wireless positioning system includes a terminal 100, a positioning server 120, and wireless communication access points.

In a terminal-based position calculation mode, a fingerprint coarse database 101 transmitted from the server 120 to the terminal 100 is included. Here, the coarse database 101 is a fingerprint database having a small capacity constructed by setting fingerprint grids to be larger when a database for indoor positioning is created.

The positioning server 120 transmits the fingerprint coarse database 101 stored in advance to the terminal 100. The terminal 100 stores the database 101 transmitted from the positioning server 120 in a memory.

The terminal 100 receives signals from the access points indoors, extracts strengths of the signals, and uses the extracted information with the coarse database 101 stored in the memory to estimate a position of the terminal 100 in a fingerprint technique.

FIG. 2 is a flowchart showing a terminal-based indoor wireless positioning method according to an embodiment of the present invention.

After the terminal enters a building, the terminal requests a positioning service of the positioning server for indoor positioning (operation S200).

When the positioning server receives the positioning service request, the positioning server requests the terminal to select a positioning calculation mode (operation S210). In this case, the terminal transmits information needed for a terminal-based position calculation mode to the positioning server (operation S220).

Last, the positioning server transmits the fingerprint coarse database 101 to the terminal (operation S230).

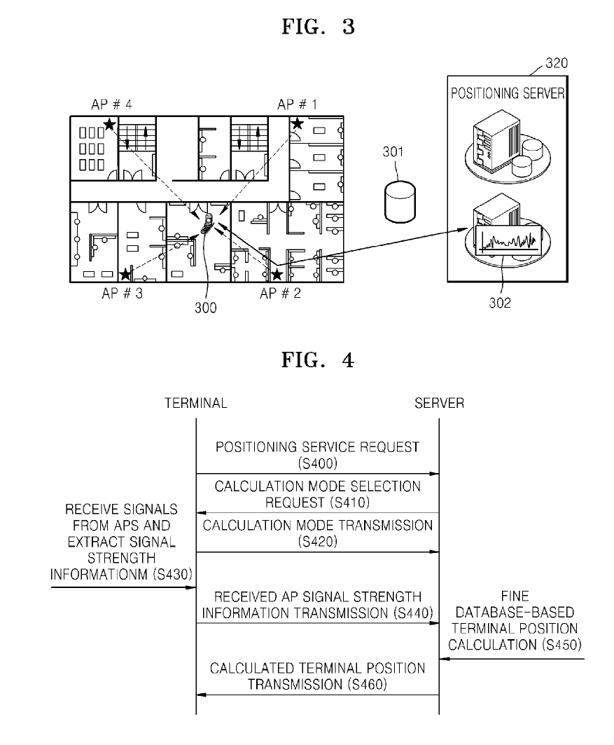

FIG. 3 is a view showing a structure of a server-based indoor wireless positioning system according to an embodiment of the present invention. Referring to FIG. 3, the indoor wireless positioning system includes a terminal 300, a positioning server 320, wireless communication access points, signal strengths 301 of the access points measured by the terminal 300 and transmitted to the positioning server 320, and a fine database 302 for fingerprints stored in the positioning server 320.

Here, the fine database 302 is a fine fingerprint database constructed by setting fingerprint grids to be small when a database for the indoor positioning is created.

The terminal 300 receives signals from the access points, extracts the signal strengths 301, and transmits the extracted signal strengths to the positioning server 320.

The positioning server 320 estimates a position of the terminal 300 in the fingerprint technique using the signal strength information 301 transmitted from the terminal 300 with the fine database 302 stored in a memory. The estimated terminal position information is transmitted to the terminal 300.

FIG. 4 is a flowchart showing a server-based indoor wireless positioning method according to an embodiment of the present invention.

After the terminal enters a building, the terminal requests a positioning service of the positioning server for indoor positioning (operation S400).

When the positioning server receives the positioning service request, the positioning server requests the terminal to select a positioning calculation mode (operation S410).

In this case, the terminal transmits information needed for a server-based position calculation mode to the positioning server (operation S420).

Thereafter, the positioning server waits for receipt of information on the signal strengths of the access points from the terminal. The terminal receives the signals from the access points for indoor positioning, extracts signal strength information (operation S430), and transmits the extracted information to the positioning server (operation S440).

The positioning server receiving the information estimates the position of the terminal on the basis of the fingerprint fine database stored in the memory in the fingerprint technique (operation S450).

Last, the positioning server transmits the estimated position information to the terminal (operation S460).

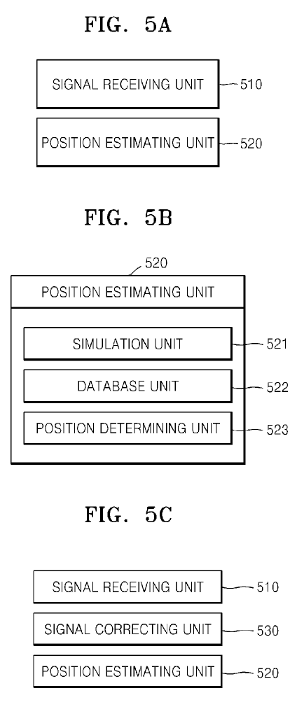

FIGS. 5A to 5C are views showing detailed structures of an indoor wireless positioning system according to an embodiment of the present invention.

FIG. 5A shows a basic structure of the indoor wireless positioning system. A signal receiving unit 510 receives first signals transmitted from wireless communication access points and measures strengths of the received first signals.

A position estimating unit 520 compares the strengths of the first signals measured by the signal receiving unit 510 with a table recording strengths of second signals predicted by a simulation of an indoor space where the terminal is currently positioned in order to estimate a current position.

FIG. 5B shows a structure of the position estimating unit 520 in detail. A simulation unit 521 predicts the strengths of the second signals through a simulation using a signal propagation attenuation model on the basis of indoor map information showing a cross-section of the indoor space, indoor wall information including the thickness and material of an indoor wall, strengths of signals transmitted from the access points, position information on the access points, and movement information on the indoor wireless positioning system.

A database unit 522 predicts the strengths of the second signals indoors where the terminal is currently positioned through a simulation for a number of the access points and records and stores the strengths of the second signals from the access points in the table.

A position determining unit 523 receives the first signals transmitted from a number of the wireless communication access points, compares the measured strength of the first signal from each access point with the table recording the strengths of the second signals predicted by the simulation of the indoor space where the terminal is currently positioned for a number of the access points, and determines a position stored in the table corresponding to a strength of a second signal with a minimum error as a current position.

FIG. 5C shows an expanded structure of the indoor wireless positioning system. A signal correcting unit 530 receives the strength of the second signal predicted by the position estimating unit 520 at the current position of the system and a third signal transmitted from the access point at a known position indoors and corrects the strength of the second signal predicted by the position estimating unit 520 according to an error calculated using a strength of the third signal.

Fingerprint database creation tools may include a software tool and a hardware tool.

The software tool creates a fingerprint database indoors based on indoor environment information. The database is divided into a coarse database and a fine database according to a size of a fingerprint grid. The simulation unit 521 may correspond to the software tool.

The hardware tool is used to correct an error made by the software tool. The hardware tool directly receives the signals from the access points at known indoor positions, calculates a position and an error on the basis of the fingerprint database, and corrects the error made by the software tool using the calculated information. According to the aforementioned construction, a reliable fingerprint database can be created using the software tool. The signal correcting unit 530 may correspond to the hardware tool.

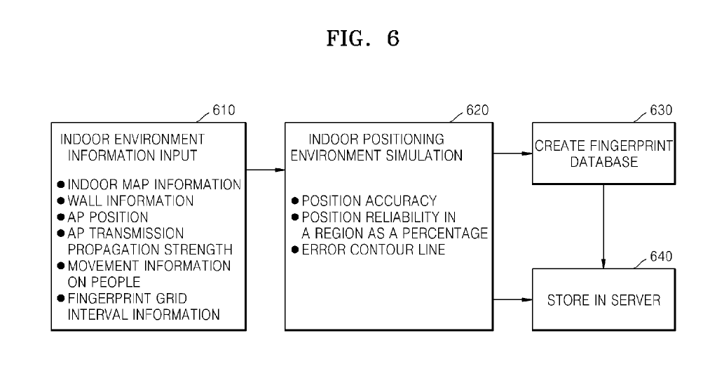

FIG. 6 is a flowchart showing a simulation process for a strength of a second signal according to an embodiment of the present invention.

First, indoor environment information 610 is input into the software tool for an indoor positioning environment analysis.

The indoor environment information 610 includes indoor map information, wall information, position information on the access points, access point transmission propagation strength information, movement information on people, and fingerprint grid interval information.

When the indoor environment information 610 is input into the software tool, the software tool performs an indoor positioning environment simulation 620. In this case, the simulation content includes position accuracy at a fingerprint grid interval indoors and can accordingly display position reliability in a region as a percentage and an error contour line indoors on a map.

Position adjustment of the access points to occupy desired position reliability in a region as a percentage and information on additional access points can be simulated.

When the desired position reliability in a region as a percentage is obtained, the fingerprint database is created (operation 630). On the basis of the indoor environment information input to the software tool, the database is created at the fingerprint grid intervals.

A database is constructed using the signal propagation attenuation model and estimating the signal strength information on the access points received at the fingerprint grid intervals on the basis of the information on the strengths of the propagation transmitted from the positions of the access points, the wall information, and the movement information on people (operation 630).

The created database is stored in the memory of the positioning server (operation 640).

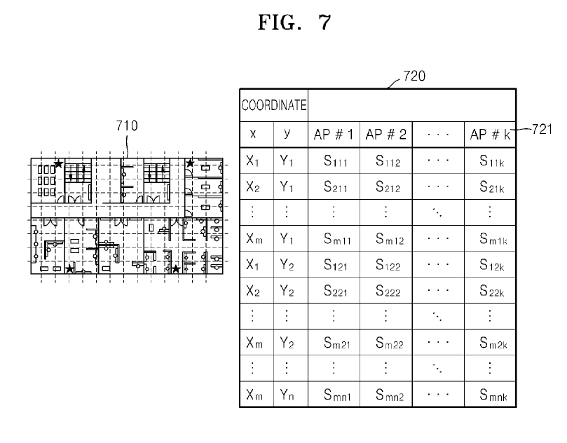

FIG. 7 is a view showing a table for strengths of second signals according to an embodiment of the present invention.

On the basis of the environment information input as a result of the fingerprint database creating process of the software tool, the strengths of the signals measured when the terminal receives the signals transmitted from the access points are simulated at the fingerprint grid intervals, and the simulated information is databased (operation 720).

An estimated strength Sₘₙₖ of a signal 721 includes a reception signal strength of the signal transmitted from an access point k having coordinates (m, n) and signal change covariance information.

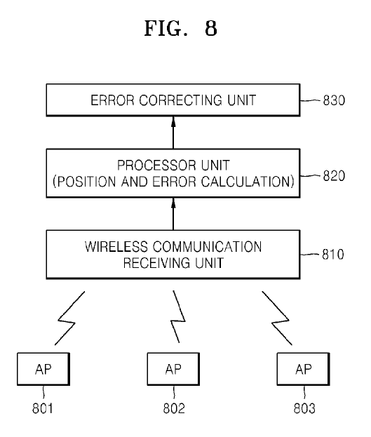

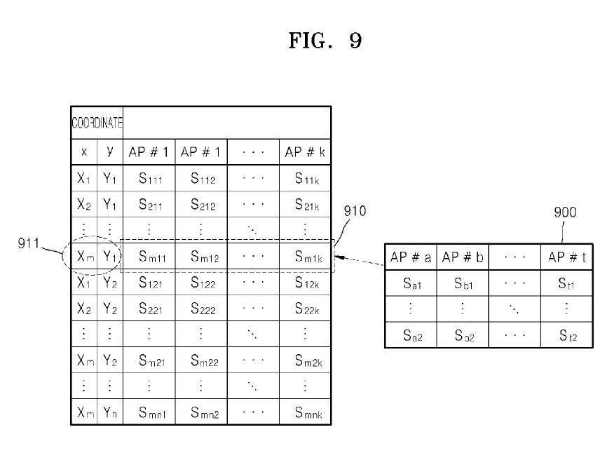

FIG. 8 is a view showing signal correction operations after a simulation of strengths of second signals according to an embodiment of the present invention.

Correction of errors of the software tool is performed by the hardware tool in operations shown in FIG. 8. Signals transmitted from access points 801, 802, and 803 at known positions indoors are received by a wireless communication receiving unit 810.

Signal strengths are extracted from the received signals, and a position is calculated by a processor unit 820 using the extracted information. Here, the fingerprint database created by the software tool 501 is used.

Thereafter, the errors are calculated using the known position information. The errors of the software tool are corrected by an error correcting unit 830 using the calculated position and error information. By means of the correction operations, the software tool can create a reliable database.

FIG. 9 is a view showing a method of estimating a position of the terminal by comparing the strengths of first signals with the table for the strengths of the second signals.

As shown in FIG. 9, the terminal receives signals from the access points for position estimating. A signal strength combination 900 for the signals received from the access points during a predetermined time is created.

In FIG. 9, S_{tz} means a strength of z-th signal received from an access point t. The signal strength combination 900 is used with the fingerprint database in order to search for an optimal matching condition 910.

According to a result of searching, a position (X, Y) 911 of the terminal can be estimated.

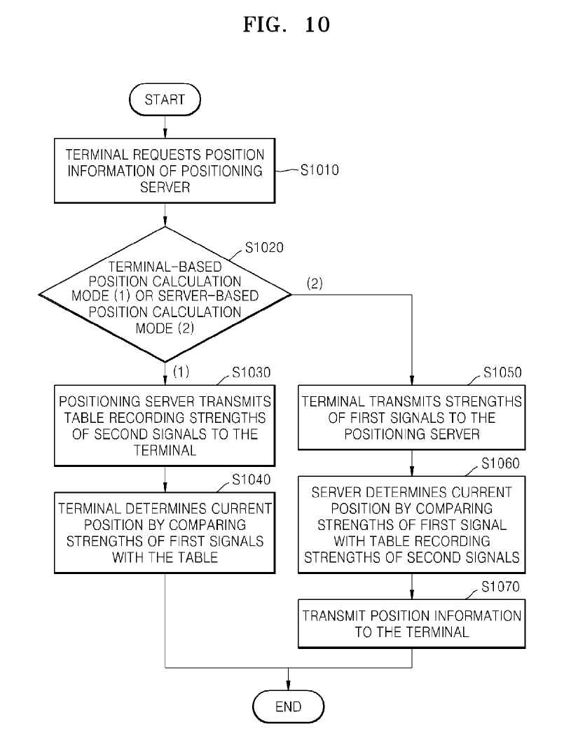

FIG. 10 is a flowchart showing an indoor wireless positioning method applying terminal-based and server-based calculation modes according to an embodiment of the present invention.

A mobile communication terminal enters an indoor space and requests information on a current position of the positioning server (operation S1010).

The positioning server receiving the request requests the terminal to select a mode from among a terminal-based position calculation mode and a server-based position calculation mode (operation S1020).

When the mobile communication terminal selects the terminal-based position calculation mode (operation 1), the positioning server provides a table recording strengths of second signals predicted by a simulation of an indoor space where the mobile communication terminal is positioned to the mobile communication terminal (operation S1030).

The terminal receives the first signals transmitted from the wireless communication access points, compares measured strengths of the first signals with the strengths of the second signals recorded in the table, and determines a position stored in the table corresponding to the strength of the second signal with a minimum error as a current position (operation S 1040).

When the mobile communication terminal selects the server-based position calculation mode (operation 2), the terminal receives the first signals transmitted from the wireless communication access points and provides measured strengths of the first signals to the positioning server (operation S1050).

The positioning server compares the provided strengths of the first signals with the table recording the strengths of the second signals predicted by the simulation of the indoor space where the mobile communication terminal is currently positioned performed by the positioning server, and determines a position stored in the table corresponding to the strength of the second signal with a minimum error as a current position (operation S1060). The determined current position is transmitted to the terminal (operation S1070).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

1. An indoor wireless positioning system comprising:
a signal receiving unit receiving first signals from wireless communication access points and measuring strengths of the received first signals; and
a position estimating unit estimating a current position by comparing the strengths of the first signals measured by the signal receiving unit with a table recording strengths of second signals predicted by a simulation for indoor space the system is currently positioned.

2. The system of claim 1, wherein the signal receiving unit receives the first signals transmitted from a number of the wireless communication access points and measures the strength of the first signal received from each access point.

3. The system of claim 1, wherein the position estimating unit comprises a simulation unit which predicts the strengths of the second signals through the simulation using a signal propagation attenuation model on the basis of indoor map information showing a cross-section of the indoor space, indoor wall information including the thickness and material of an indoor wall, strengths of signals transmitted from the access points, position information on the access points, and movement information on the system.

4. The system of claim 1, wherein the position estimating unit comprises a database unit which predicts the strengths of the second signals in the indoor space the system is currently positioned through the simulation for a number of the access points and records and stores the strength of the second signal with respect to each access point in the table.

5. The system of claim 1, wherein the position estimating unit comprises a position determining unit which receives the first signals transmitted from a number of the wireless communication access points, compares the measured strength of the first signal from each access point with the table recording the strengths of the second signals predicted by the simulation of the indoor space the system is currently positioned for a number of the access points, and determines a position stored in the table corresponding to a strength of a second signal with a minimum error as a current position.

6. The system of claim 1, further comprising a signal correcting unit which receives the strength of the second signal predicted by the position estimating unit at the current position of the system and a third signal transmitted from the access point at a known position in the indoor space and corrects the strength of the second signal predicted by the position estimating unit according to an error calculated using a strength of the third signal and the strength of the second signal.

7. An indoor wireless positioning method comprising:
(a) receiving first signals transmitted from wireless communication access points and measuring strengths of the received first signals; and
(b) estimating a current position by comparing the strengths of the first signals measured in (a) with a table recording strengths of second signals predicted by a simulation for indoor space the system is currently positioned.

8. The method of claim 7, wherein in (a), the first signals transmitted from a number of the wireless communication access points are received, and the strength of the first signal received from each access point is measured.

9. The method of claim 7, wherein (b) comprises predicting the strengths of the second signals through the simulation using a signal propagation attenuation model on the basis of indoor map information showing a cross-section of the indoor space, indoor wall information including the thickness and material of an indoor wall, strengths of signals transmitted from the access points, position information on the access points, and movement information on the system.

10. The method of claim 7, wherein (b) comprises predicting the strengths of the second signals in the indoor space the system is currently positioned through the simulation for a number of the access points and recording and storing the strength of the second signal for each access point in the table.

11. The method of claim 7, wherein (b) comprises receiving the first signals transmitted from a number of the wireless communication access points, comparing the measured strength of the first signal from each access point with the table recording the strengths of the second signals predicted by the simulation of the indoor space the system is currently positioned for a number of the access points, and determining a position stored in the table corresponding to a strength of a second signal with a minimum error as a current position.

12. The method of claim 7, further comprising receiving the strength of the second signal predicted in (b) at the current position and a third signal transmitted from the access point at a known position in the indoor space and correcting the strength of the second signal predicted in (b) according to an error calculated using a strength of the third signal.

13. An indoor wireless positioning method using an indoor wireless positioning system constructed with a mobile communication terminal and a positioning server, the method comprising:
(a) the mobile communication terminal entering an indoor space and requesting information on a current position of the positioning server;
(b) the positioning server receiving the request requesting the mobile communication terminal to select a mode from among a terminal-based position calculation mode and a server-based position calculation mode;
(c) when the mobile communication terminal selects the terminal-based position calculation mode, the positioning server providing a table recording strengths of second signals predicted by a simulation of the indoor space where the mobile communication terminal is currently positioned to the mobile communication terminal; and
(d) the mobile communication terminal receiving first signals transmitted from wireless communication access points, comparing measured strengths of the first signals with the strengths of the second signals recorded in the table, and determining a position stored in the table corresponding to a strength of a second signal with a minimum error as a current position.

14. The method of claim 13, further comprising:
(e) when the mobile communication terminal selects the server-based position calculation mode in (c), the terminal receiving the first signals transmitted from the wireless communication access points and providing the measured strengths of the first signals to the positioning server; and
(f) the positioning server comparing the provided strengths of the first signals with the table recording the strengths of the second signal predicted by the simulation of the indoor space where the mobile communication terminal is currently positioned performed by the positioning server and determining a position stored in the table corresponding to a strength of a second signal with a minimum error as a current position.

15. The method of claim 13, wherein in (d), the strength of the second signal and a third signal transmitted from the access point at a know position in the indoor space are received, and the strength of the second signal is corrected according to an error calculated using a strength of the third signal and the strength of the second signal.

16. The method of claim 14, wherein in (e), the strength of the second signal and a third signal transmitted from the access point at a known position in the indoor space are received, and the strength of the second signal is corrected according to an error calculated using a strength of the third signal and the strength the second signal.
